(19) United States
(12) Patent Application Publication
(10) Pub. No.: US 2003/0080545 A1
(43) Pub. Date: May 1, 2003

(54) Protective covering for controlling contaminants associated with material handling equipment

(76) Inventor: Alan Rosenkranz, Riviera Beach, FL (US)

Correspondence Address: Gregory J. Lavorgna, Drinker Biddle & Reath LLP, One Logan Square, 18th & Cherry Streets, Philadelphia, PA, 19103-6996, US

(21) Appl. No.: 10/198,630

(22) Filed: Jul. 17, 2002

Related U.S. Application Data
(63) Continuation-in-part of application No. 09/999,534, filed on Oct. 31, 2001.

(51) Int. Cl. B60R 13/00

(52) U.S. Cl. 280/762

(57) ABSTRACT

A protective covering to control the spread of contaminants associated with material handling equipment and containers. The protective covering may comprise at least one sheet of a flexible substantially air-tight material that may be adapted to enclose various types of material handling equipment. The protective covering may also include collectors at specific locations so as to attract and collect contaminants raised by material handling equipment while running across a floor.

### RELATED APPLICATIONS

This application is a continuation-in-part of U.S. patent application Ser. No. 09/999,534, filed Oct. 31, 2001. The entire disclosure of said application is incorporated herein by reference.

### FIELD OF THE INVENTION

The invention relates to material handling, particularly within controlled environments where it is important to control potential sources of contamination. The invention is directed to preventing contaminants associated with material handling equipment, such as pallet jacks, forklifts, hand trucks and platform trucks, for example, from contaminating ambient air while handling materials and traveling across supporting surfaces. The present invention is also directed to preventing contaminants associated with equipment and materials brought into clean rooms such as gas cylinders, Dewar flasks, drums and tool boxes, for example.

### BACKGROUND OF THE INVENTION

Controlled environments, such as “clean rooms,” quite often encompass areas where large quantities of sensitive materials are moved in and out on a continuing basis. For example, pharmaceuticals are manufactured and packaged, or otherwise arranged for packaging, in clean rooms. As part of the manufacturing process, raw materials are transported into and out of the clean room in large drums. To facilitate transport, several drums are typically placed on a single pallet. The pallets are often moved by a worker using material handling equipment such as pallet jacks and forklifts. Individual or stacked drums may be transported by means of a hand truck or platform truck.

Operating pallet jacks and forklifts within clean rooms or other controlled environments presents significant contamination issues. Forklifts are self-propelled and typically produce gaseous exhaust and other related contaminants. Forklifts exist that operate on electric power in order to reduce emissions, but they are not always used in areas having high standards of cleanliness. Also, electric forklifts have moving parts, which require lubrication. Grease and grime typically associated with such equipment presents a threat to the stringent air quality and other requirements of a controlled environment.

Furthermore, even if they are not used in the clean rooms themselves, forklifts are commonly used to transport materials adjacent to or in close proximity to higher order clean rooms, after which a pallet jack or hand truck is used to move the product the short distance into the clean room. In such situations, contaminants may be transferred from the forklift to the pallet, and then transmitted into the clean room by the pallet jack, hand truck or platform truck.

In addition to the potential contaminants inherent in the forklift itself, contaminants from outside a controlled environment may be brought into the controlled environment by the forklift when bringing material into a clean room from outside. In order to maintain the integrity of the controlled environment, it is, therefore, necessary to clean the forklift prior to entering the controlled environment. That can be very cumbersome, time consuming, and expensive.

Pallet jacks and hand trucks are generally not self-propelled and, for that reason, do not produce emissions. However, pallet jacks typically use hydraulic fluid, which can leak. In addition, pallet jacks and hand trucks are commonly used in controlled environments having much higher standards than those where forklifts are normally found. As such, the contamination issues presented by pallet jacks and hand trucks may quite often be more critical than the contamination issues presented by forklifts in less stringent environments.

Containers such as drums, gas cylinders, tanks and Dewar flasks, etc. are generally reusable containers that are refilled remotely and brought into clean rooms. The containers may be handled and transported several times before ultimately arriving at the clean room where they are to be used. This handling increases the opportunity for contamination. Furthermore, these containers are heavy and awkward to manipulate and are frequently moved about a clean room by the use of a hand truck.

Many clean rooms also utilize robotics to perform highly precise and repetitive tasks. An example of such a robotic device would be an articulating robotic arm. An articulating arm is much like a human arm in that it has joints and moves in a similar way. Some articulating arms are capable of 360° rotation. An articulating arm may run hydraulically or electrically and generally requires lubrication. As in the case of the pallet jack, hydraulic fluid or lubricants may leak contaminating the clean room.

A need therefore exists for preventing the spread of contaminants in controlled environments. by controlling contaminants associated with pallet jacks, forklifts, hand trucks, platform trucks, and other equipment when such equipment is used in a controlled environment. A need also exists for preventing the spread of contaminants in controlled environments by controlling contaminants associated with containers such as drums, Dewar flasks, gas cylinders and tool kits and other containers when such containers are used in a controlled environment.

### SUMMARY OF THE INVENTION

In accordance with the present invention, there is provided a protective covering that may be used with material handling equipment to control the contaminants associated with such equipment. In one embodiment the protective covering may be used with a forklift. In another embodiment the protective covering may be used with a pallet jack. In a further embodiment the protective covering may be used with a hand truck. In a still further embodiment the protective covering may be used with a platform truck. In a still further embodiment the protective covering may be used with a container. In a still further embodiment the protective covering may be used with an articulating arm. The protective covering includes at least one sheet of a flexible substantially air-tight material. The protective covering may also include, in one embodiment, a plurality of collectors that collect contaminants so that they are not dispersed into the ambient air. In another embodiment the protective covering may also include an inner thermal insulating layer or moisture-absorbing layer or batting. The protective covering may also include, in another embodiment, an anti-static layer or an anti-microbial layer.

Pharmaceutical and semiconductor clean rooms are used herein to illustrate the present invention. However the invention may be practiced in other settings where hygienic conditions are important. Another example of an application of the present invention would be in a food-processing environment such as, for example, in a meat packaging plant. In a meat packaging plant large pieces of meat are transported to different locations. The meat is sometimes transported via forklifts, pallet jacks and hand trucks. The present invention, when utilized in such a setting, would serve not only to maintain the cleanliness of the meat but also to maintain the cleanliness of the equipment used to transport the meat, thus avoiding cross contamination.

### BRIEF DESCRIPTION OF THE DRAWINGS

For purposes of illustrating the invention, the drawings show forms that are presently preferred; it being understood, however, that this invention is not limited to the precise arrangements and instrumentalities shown.

FIG. 1 is an isometric view of a forklift with its forks and the support steel that supports the forks enclosed by a protective covering in accordance with an embodiment of the present invention.

FIG. 1A is an isometric view of the protective covering shown in FIG. 1 wherein the protective covering includes bellows in accordance with an embodiment of the present invention.

FIG. 2 is an isometric view of a pallet jack enclosed by a protective covering having openings for the wheels and having collectors, in accordance with an embodiment of the present invention.

FIG. 3 is a rear isometric view of a pallet jack enclosed by a protective covering having a rear opening, shown partially closed, in accordance with an embodiment of the present invention.

FIG. 4 is an isometric side elevation view of a pallet jack enclosed by a protective covering having openings for the wheels and having collectors, in accordance with an embodiment of the present invention.

FIG. 5 is an enlarged side isometric view, partially in section, of an arrangement of collectors attached to a protective covering for attracting and collecting contaminants, in accordance with an embodiment of the present invention.

FIG. 5A is a further enlarged isometric view, partially in section, of the rear wheel and a portion of the arrangement of collectors shown in FIG. 5, in accordance with the present invention.

FIG. 5B is a further enlarged isometric view, partially in section, of the front wheel and a portion of the arrangement of collectors shown in FIG. 5, in accordance with the present invention.

FIG. 6A is a section blown-up to show the structure of a typical collector having a second surface comprising a plurality of thin layers having an adhesive thereon for collecting contaminants, in accordance with the present invention.

FIG. 6B is a section blown-up to show the structure of a typical collector having a second surface comprising a plurality of thin layers having small hooks on an inner surface and small loops on an outer surface, in accordance with the present invention.

FIG. 7 is an isometric view of a frame including a means for cleaning the front wheel of a pallet jack, in accordance with the present invention.

FIG. 8 is an isometric view of a frame including a means for cleaning the rear wheel of a pallet jack, in accordance with the present invention.

FIG. 9 is an elevation view showing the frame of FIG. 7 attached to the front wheel of a pallet jack and the protective covering attached to the frame, in accordance with the present invention.

FIG. 10 is an elevation view showing the frame of FIG. 8 attached to the rear wheel of a pallet jack and the protective covering attached to the frame, in accordance with the present invention.

FIG. 11 is an isometric view of a hand truck enclosed by a protective covering in accordance with an embodiment of the present invention.

FIG. 11A is an enlarged partial view of the protective covering in relation to the axle of a hand truck, in accordance with one embodiment of the present invention.

FIG. 11B is an enlarged partial view of the protective covering in relation to the axle of a hand truck, in accordance with another embodiment of the present invention.

FIG. 11C is an enlarged partial view of the protective covering in relation to the axle of a hand truck, in accordance with yet another embodiment of the present invention.

FIG. 12 is an isometric view of a drum enclosed by a protective covering in accordance with an embodiment of the present invention, showing one way of closing the covering.

FIG. 12A is an isometric view of a drum enclosed by a protective covering in accordance with an embodiment of the present invention, showing another way of closing the covering.

FIG. 12C is an isometric view of a drum enclosed by a protective covering in accordance with an embodiment of the present invention, showing still another way of closing the covering.

FIG. 13 is an isometric view of a gas cylinder enclosed by a protective covering in accordance with an embodiment of the present invention.

FIG. 14A is an enlarged bottom view along the lines 14-14 in FIG. 13, showing one way of closing the covering around a hose in accordance with an embodiment of the present invention.

FIG. 14B is an enlarged bottom view along the lines 14-14 in FIG. 13, showing another way of closing the covering around a hose in accordance with an embodiment of the present invention.

FIG. 14C is an enlarged bottom view along the lines 14-14 in FIG. 13, showing still another way of closing the covering around a hose in accordance with an embodiment of the present invention.

FIG. 15 is an isometric view of a Dewar flask enclosed by a protective covering in accordance with an embodiment of the present invention.

FIG. 15A is a sectional view taken along line A-A of FIG. 15 of the protective covering of the present invention.

FIG. 16 is an isometric view of an articulating arm enclosed by a protective covering in accordance with an embodiment of the present invention.

### DETAILED DESCRIPTION OF THE DRAWINGS

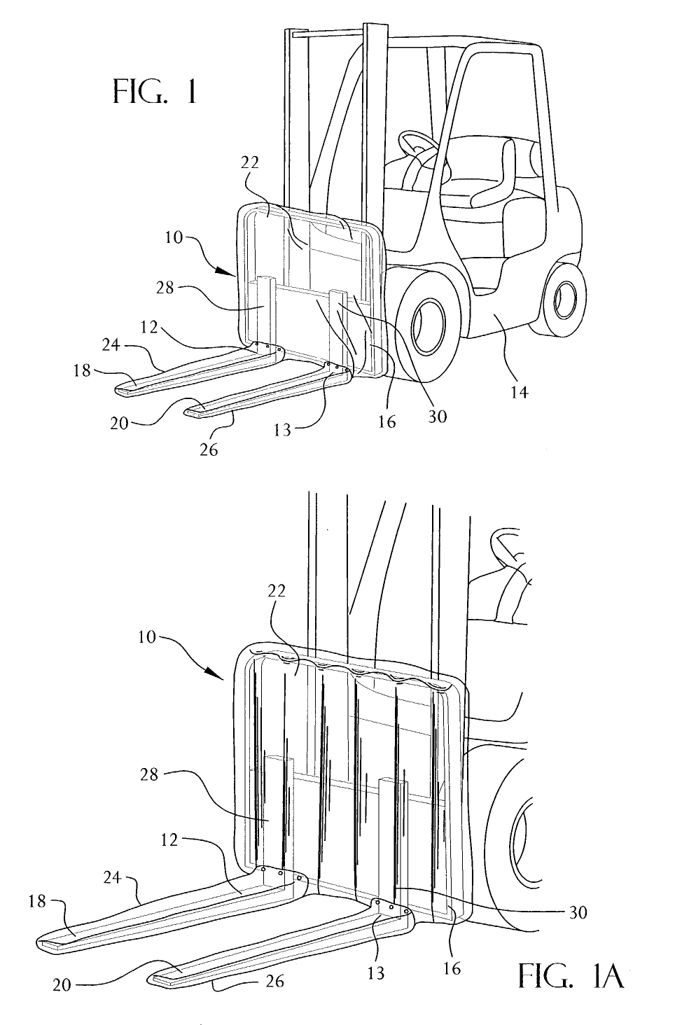

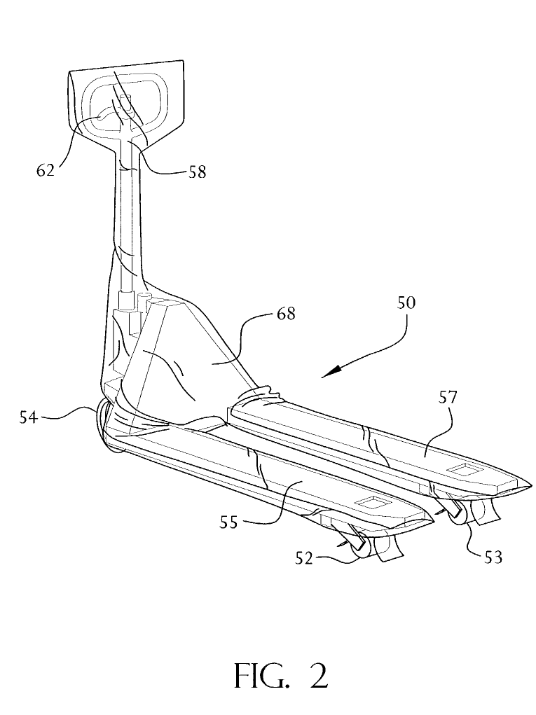

Referring now to the figures, wherein like reference numerals identify corresponding or similar elements throughout the several views, the present invention is illustrated in one or more configurations that are currently preferred. Referring to FIGS. 1 and 2, embodiments of a protective covering in accordance with the present invention are shown and indicated generally by reference numerals 10, 50.

The protective covering is adapted to enclose various material handling apparatuses so as to minimize or prevent contamination. It should be noted that the terms material handling equipment and material handling apparatus are used interchangeably, as are the terms protective covering, covering, protective cover and cover. The protective covering may be a single unit or a plurality of units capable of being releasably attached to each other so as to enclose all or a portion of an apparatus for handling material. The covering may include sleeves for enclosing material handling apparatuses having tines. The protective coverings that have sleeves may also be adapted to enclose other portions of a material handling apparatus depending on the structure, characteristics and function of the apparatus. The covering may also include a body portion that may act as a flexible cover for a support assembly of a particular material handling apparatus. The body portion may be referred to as a flexible cover or vice versa. The protective covering may be made of any flexible substantially airtight material and may also be reinforced with a second material as appropriate. The protective covering is preferably but not necessarily made of a reinforced polymer sheet or a TYVEK® sheet. TYVEK, a registered trademark of E. I. DuPont DeNemours and Co., is a tear resistant material. The covering may also be made from Securon which is a breathable barrier fabric made by BBA Nonwovens

An example of a polymer for use with the present invention is polyethylene. The thickness of the protective covering may vary from approximately 4 mils to approximately 26 mils with a thickness of between approximately 12 mils and approximately 18 mils being preferred.

To further control contamination, the cover may include collectors that attract and/or collect air borne contaminants. The collectors may be located at various locations on either an inner surface or outer surface of the cover. For example, collectors may be located along a bottom surface of the cover and adjacent to at least a portion of any openings in the cover. The collectors have a first surface that may be attached to the cover by way of a cohesive bond, for example, and a second surface that is sticky, tacky or otherwise capable of holding onto items that come in contact with the second surface. The collectors may include removable layers having an adhesive coating or a hook and loop fastener, such as a VELCRO® fastener, in order to collect contaminants. VELCRO is a registered trademark of Velcro Industries, B.V.

Protective coverings that are configured as a single unit may include openings of various sizes that are located in various locations depending on the type of apparatus being enclosed. Typically, but not necessarily, the location of the opening may be positioned so that the cover encloses the desired portions of an apparatus while enabling a single individual to put the cover on the apparatus.

In the embodiment of the present invention shown in FIG. 1, the protective covering 10 is adapted to completely enclose elements of a forklift that are most commonly and frequently in contact with the product being carried. A typical forklift includes tines 12 and 13, as well support steel 16 supporting the tines 12, 13. Tines 12, 13 of forklift 14, as well as the steel 16 that supports them, are frequently exposed to the materials they carry. In the pharmaceutical industry, for example, chemicals and other sensitive materials transported via forklift are typically contained within drums that are loaded onto pallets. During transport from one area to another, those materials, which in many cases are often in the form of a powder, can escape from the drums and contaminate portions of the forklift. The elements of a forklift that are most susceptible to becoming contaminated in such circumstances are the tines 12, 13 and the support steel 16.

In areas or operations comprising controlled environments, such as clean rooms, dirty or tainted forklifts are a potential source of contamination of the environment. Industries that manufacture, process, and/or package, pharmaceuticals, chemicals or other sensitive materials are required to follow what are known as Good Manufacturing Procedures (“GMP”), which are designed to eliminate potential sources of contamination. Contaminated forklifts not only present a potential source of contamination to the product being transported but also to the areas in which the forklift is located.

The protective covering 10 shown in FIG. 1 minimizes the risk of a forklift becoming contaminated as well as the risk of a forklift contaminating a controlled environment. In a preferred embodiment, the protective covering 10 may comprise three separate units—a first sleeve 18, a second sleeve 20 and a flexible cover 22. Those three elements may be made of any flexible, preferably air-tight material. The material may be a polymer such as, for example, polyethylene, although other material may be used as well. For example, the protective covering 10 may be made out of a TYVEK® sheet, which is flexible and resistant to tears. The first sleeve 18 is adapted so that it may slideably engage the horizontal portion 24 of the first tine 12. The second sleeve 20 is adapted so that it may slideably engage a horizontal portion 26 of the second tine 13 in similar fashion. The flexible cover 22 is dimensioned to enclose vertical portions 28, 30 of the tines 12, 13 as well as the support steel 16 that supports the tines 12, 13.

The first sleeve 18 and second sleeve 20 of the protective covering 10 may be integral with cover 22, or preferably are releasably attached to flexible cover 22 as shown in FIG. 1. The sleeves 18, 20 may be attached to the flexible cover 22 by any of several means. For example, the sleeves 18, 20 may be releasably attached to the flexible cover 22 with VELCRO® fasteners, snaps, buttons, sliding zippers or any other suitable fastening device.

The flexible cover 22 may be configured in accordance with the specific characteristics of the forklift 14 on which the covering 10 is being used. Some forklifts have tines that are movable toward and away from each other. Thus, the flexible cover 22 may be corrugated or pleated, like a bellows as shown in FIG. 1A, to more readily accommodate the opening and closing of the tines 12, 13. The sleeves 18, 20 and flexible cover 22 may also be configured differently to accommodate specific characteristics of the operation being performed. For instance, if an operation causes significant wear and tear to the sleeves 18, 20 but not the cover 22, the sleeves 18, 20 may be made from a lighter gauge material, so that they are disposable and easily replaced, while the cover 22 may remain in place for extended periods of time. Such considerations may mandate variations in material type, material thickness, how the sleeves are attached to the cover, and whether the material is heavily reinforced or not.

Referring now to FIG. 2, another embodiment of the present invention is shown wherein the protective covering is adapted for use with a pallet jack. In FIG. 2, the protective covering of this embodiment is indicated generally with reference numeral 50. Pallet jacks typically include first and second tines 55, 57. Pallet jacks are generally considered to be cleaner than forklifts and, therefore, are more likely to be used in controlled environments having stricter guidelines then environments where forklifts are used. In fact, forklifts that are normally used to transport materials to low level clean rooms, for example, are often prohibited from entering higher level clean rooms. In that case, materials transported via forklift are typically left outside the door, and a worker with a pallet jack brings the materials into the higher level clean room. As a result, pallet jacks are often required to conform to strict levels of cleanliness. However, pallet jacks, while not self propelled, do, in fact, present contamination issues. As discussed above, pallet jacks use hydraulic fluid and include a significant number of moving parts. Furthermore, because pallet jacks are often used in high level clean rooms, debris created by running a pallet jack across a floor outside the clean room (or even inside the clean room), presents contamination problems. Contaminants raised while traveling outside a clean room may attach themselves to the pallet jack and be brought inside the clean room. Contaminants raised while traveling within a clean room may become suspended in the clean room's atmosphere.

The protective covering 50 shown in FIG. 2 minimizes the risk of a pallet jack becoming contaminated, as well as the risk of a pallet jack contaminating a controlled environment. As can be seen, the protective covering 50 is configured to enclose an entire pallet jack while providing openings for a pair of front wheels 52, 53 and a rear wheel 54. In a preferred embodiment, the protective covering 50 is a single unit adapted so that it can easily be slipped on from the front of the pallet jack. The protective cover 50 may be made from the same material as protective cover 10. When the protective covering 50 is in place, it is loose enough to permit an operator to operate the triggering mechanism 62 while the pallet jack is covered.

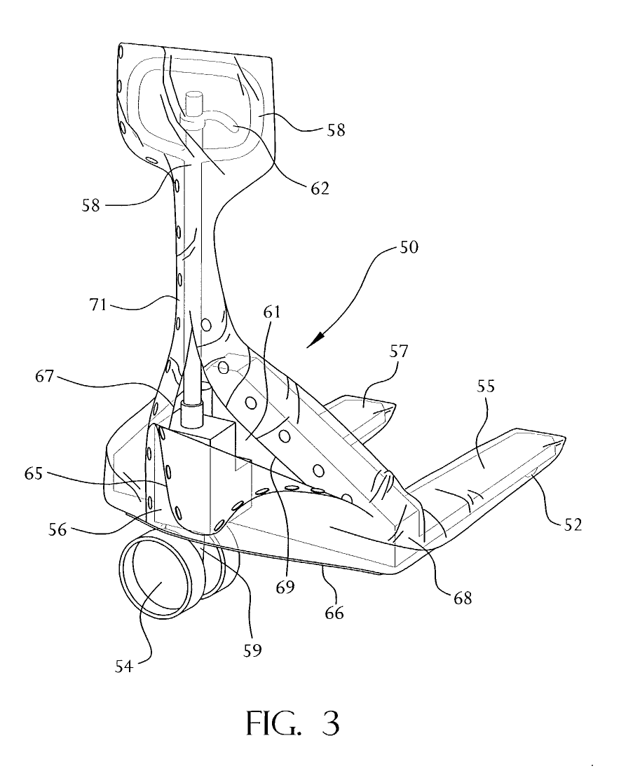

FIG. 3 is a rear view of a pallet jack enclosed by protective covering 50. The protective covering 50 has an opening 61 (shown partially open) in the rear for slipping the cover 50 on from the front of the pallet jack. The opening 61 may be releasably closed by a plurality of fasteners, such as snaps, shown in FIG. 3. The protective covering 50 is designed such that, when it is in place, the underside of the housing 56, above the rear wheel 54, is sealed so that contamination originating in the housing is prevented from escaping the covering 50. In the embodiment shown in FIG. 3, an openable rear panel 65 covers the rear opening 61. The rear panel 65 includes a first slit 67 that is approximately parallel to an axis defined by the handle 58 and a second slit 69 that is to the right of the first slit 67. In the embodiment shown in FIG. 3, where there is no frame (the frame is explained in detail below), it should be understood that the slit 67 extends downward to the bottom surface above the rear wheel so as to provide an opening at the bottom surface to accommodate a connection between the rear wheel 54 and the housing 56. It should also be understood that the second slit 69 could be on the left or right of the first slit 67. The dimensions of slits 67 and 69, as well as the distance between them, will vary depending upon how big an opening is needed to enable the covering 50 to be slipped on from the front of pallet jack as well as what accommodations are being made for the connection between the rear wheel 54 and the housing 56. As noted above, the first slit 67 is approximately parallel to a vertical axis defined by the handle 58 so that it is approximately aligned with a vertical post 59 that connects housing 56 and wheel 54. The first slit 67 is configured to wrap around post 59 to seal the underside of the housing 56 while accommodating the rear wheel 54. Above the rear panel 65 is a third slit 71 (shown completely closed) extending upward from the top of the rear panel 65 to approximately above the handle 58. That slit 71 may also be releasably closed by a plurality of fasteners. While three slits located at particular locations are shown, any number of slits at various locations having various dimensions may be used to provide an opening anywhere in the cover 50 for slipping the cover 50 on and off the pallet jack.

In FIG. 3, cover 50 is shown partially open to illustrate an example of how the covering 50 may be opened to place it over or remove it from the pallet jack. As can be seen from FIG. 3, the rear portion may be opened so that the cover 50 may be slipped onto the forks 55, 57, pulled up over the handle 58 and snapped shut. When the cover is in place, it does not interfere with the normal operation of the pallet jack. While a particular arrangement is shown in FIG. 3, with the opening and snaps in a particular position, it is important to note that those items may be in any arrangement that enables the covering 50 to slip onto the forks and enclose not only the forks 55, 57 but also the housing 56 and handle 58. To this point, snaps have been used when describing the opening and closing of opening 61 and slits 67, 69, and 71. However, snaps are a mere example of one fastening device that can be used. Any suitable fastening device known in the art can be used and is well within the scope of the invention.

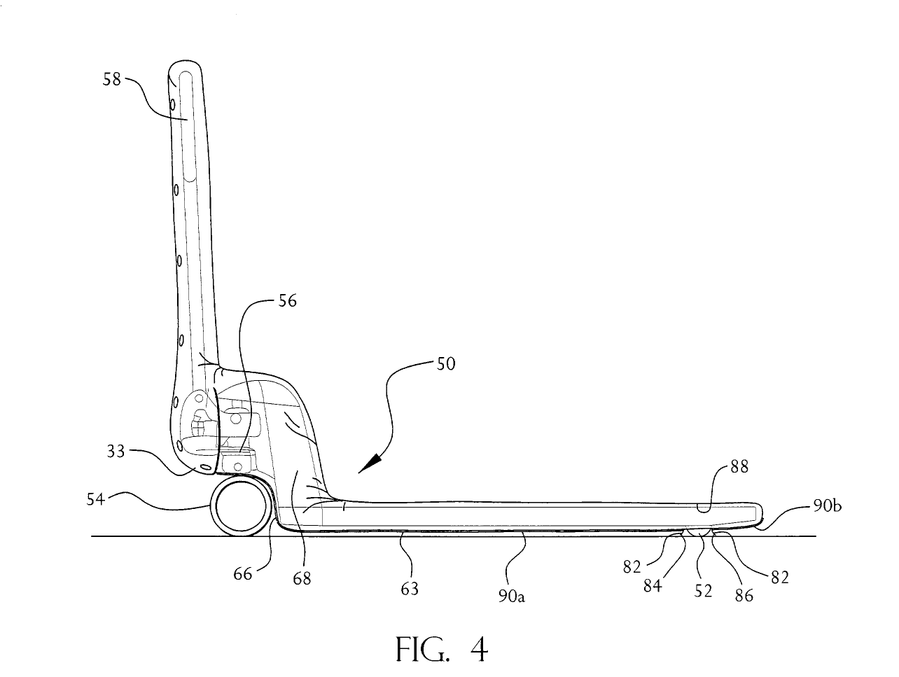

Referring now to FIG. 4, a side elevation view of a pallet jack is shown enclosed by the cover 50. In FIG. 4, a plurality of collectors 66, 84, 86, 88, 90a, and 90b are arranged along an underside 63 of the cover 50 to collect contaminants raised when the pallet jacks travels across the floor. The collectors of the present invention include a first surface that is attached to either an inner or outer surface of the cover 50 by way of a cohesive bond, for example. The collectors also include a second sticky surface for collecting debris and other contaminants raised as a result of moving the pallet jack along the floor. The collectors may be configured in any arrangement, in any suitable size and with any degree of contaminant attraction and collection ability. By way of example, the particular arrangement, size and degree of contaminant attraction and collection ability may vary according to the pallet jack being used, the environment in which the pallet jack is to be used and the type of material being handled.

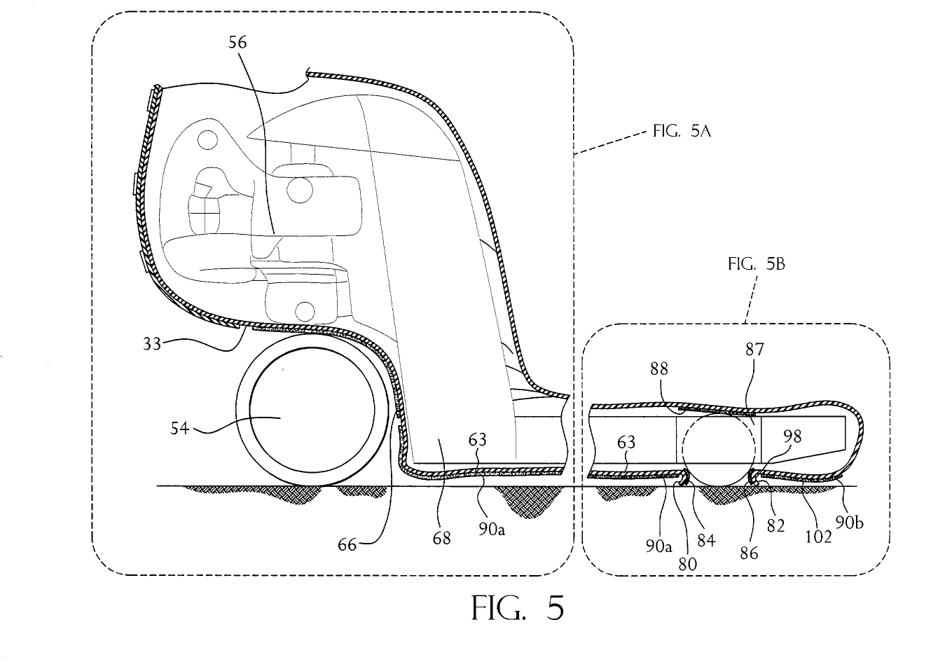

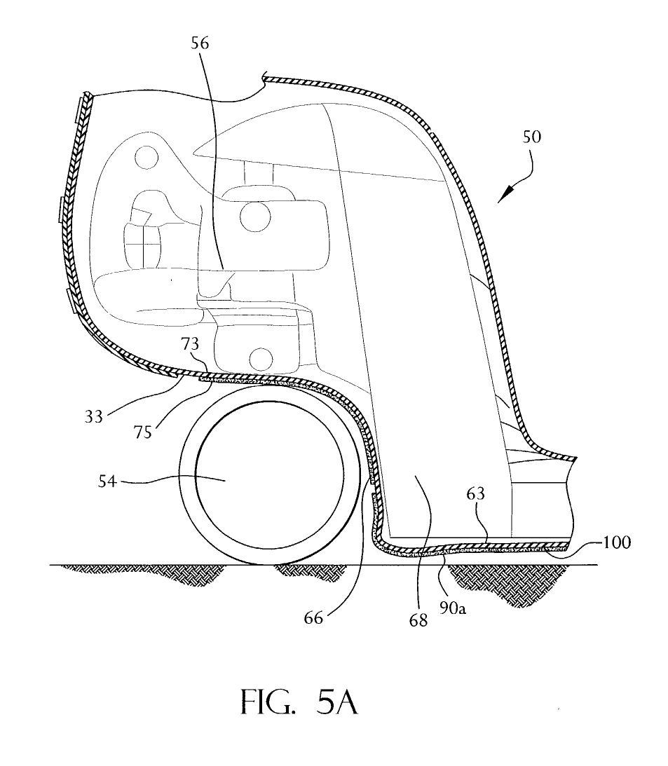

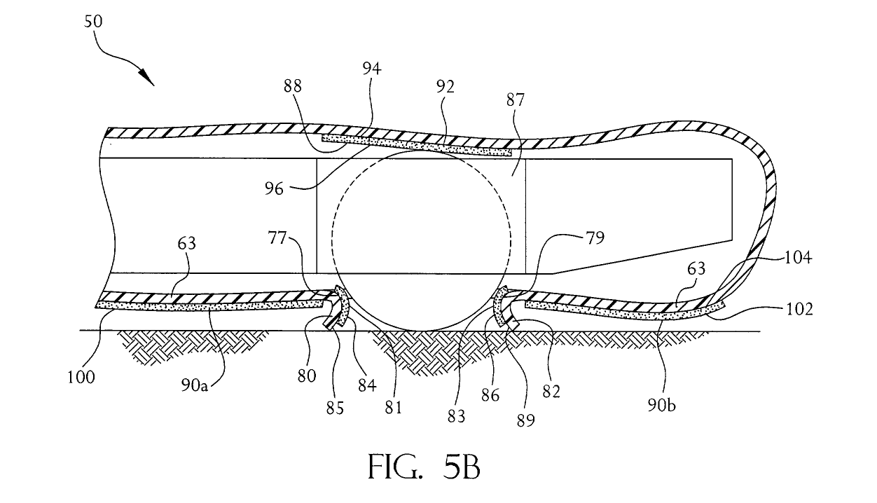

FIG. 5 shows an enlarged view of an example of an arrangement of collectors for attracting and collecting contaminants. As can be seen from FIG. 5, collectors 66, 84, 86, 88, 90a and 90b are all arranged at various locations on the protective cover 50. While the collectors are shown and identified separately, two or more of the collectors may be combined so that they are one contiguous piece. For instance, while collector 66 and 90a are shown separately with a small gap between them, they may be combined into a single collector if desired.

Referring now to FIG. 5A, collector 66 is located above the rear wheel 54 and below the housing 56 near the rear of the pallet jack. Collector 66 includes a first surface 73 and a second surface 75. The first surface 73 is attached to an outer surface 33 of the covering 50 above the rear wheel 54. The first surface 73 of the collector 66 and the outer surface 33 of the cover 50 may be attached by way of a cohesive or any other type of bond capable of fixedly joining the two surfaces 73, 33 together. The second surface 75 of collector 66 may be a sticky surface appropriate for collecting debris and other contaminants raised as a result of moving the pallet jack along the floor. The size of the collector 66 may vary according to the particular configuration of the pallet jack being enclosed by the cover 50, as mentioned above. For example, it may be desirable to increase the size of the collector 66 to encompass all the available surface area in and around the rear wheel 54 depending on the size of the pallet jack, the work being done and the environment in which the work is being done.

Moving to FIG. 5B, collectors 84, 86 and 88 are attached to the cover 50 in proximity to each of the front wheels 52, 53. For the sake of brevity, only the collectors at wheel 52 and fork 55 will be described, but it should be noted that the collectors at wheels 52, 53 and forks 55, 57 are identical. As can be seen in FIG. 5B, flaps 80, 82, similar to vehicle mud flaps, may be located at the front wheels with a collector 84, 86 attached thereto. Collectors 84, 86, like collector 66, also include a first surface 77, 79 and a second surface 81, 83. The first surfaces 77, 79 of collectors 84, 86 are attached to inner surfaces 85, 89 of flaps 80, 82, respectively. A collector 88 may also be located on an inner surface 92 of the covering 50 directly above wheel opening 87, found in most pallet jacks. First surface 94 of collector 88 is attached to the inner surface 92 of the covering 50. Collector 88 also has a second surface 96. The first surfaces 77, 79, 94 of collectors 84, 86, 88 are attached to the inner surfaces 85, 89, 92 of the cover 50 similar to how the first surface 73 (shown in FIG. 5A) of collector 66 is attached to the outer surface 33 of the cover 50.

Referring to FIGS. 5A and 5B, a portion of second surfaces 75, 96 of collectors 66, 88 are shown in contact with their respective wheels. However it should be understood that they do not have to be, as continuous cleaning of pallet jack wheels may not be necessary in every case.

As shown in FIGS. 5A and 5B, collectors 90a, 90b may also be attached at an underside 63 of the cover 50 and may be adapted to fill-in spaces not covered by other collectors 66, 84, 86, and 88. Collectors 90a and 90b are shown running along the underside 63 of cover 50 between collector 66 and flap 80 and outward from flap 82 toward the front of fork 55, respectively. Collectors 90a and 90b may, however, be located at other locations on the cover 50 depending on need. Furthermore, while collector 90b is shown extending to a particular point, it may be any suitable length. To illustrate that point, collector 90b is shown extending to one point in FIG. 5B and another point in FIG. 4. Collectors 90a and 90b comprise a structure that is identical to collectors 66, 84, 86, and 88 and are attached to the cover 50 in an identical fashion as collectors 66, 84, 86, and 88. However, a second surface 100, 102 of collectors 90a and 90b may vary from the other collectors in that a higher or lower degree of contaminant attraction and collection may be required at certain locations.

Collectors 66, 84, 86, 88, 90a, and 90b may be made from a variety of materials and certain collectors may be made from one material while others are made from another material.

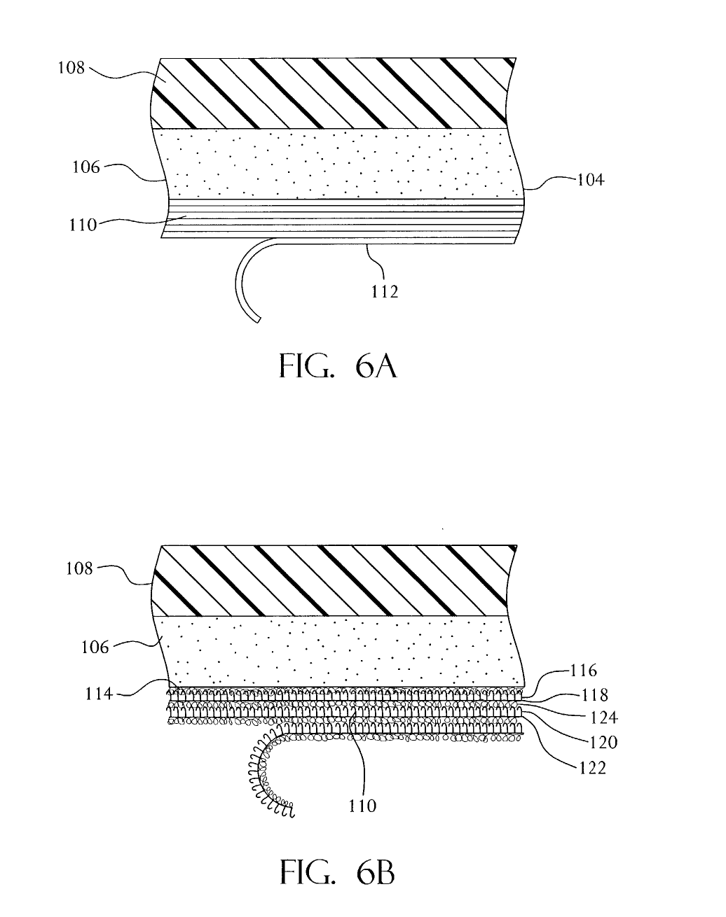

Referring now to FIGS. 6A and 6B, a blow-up of an example of a typical connection of a collector 104 to a portion of a cover 108 is shown. (Collector 104 and cover 108 are generic examples of the collectors and covers from the prior figures.) The first surface 106 of the collector 104 is attached to a surface (inner or outer) 108 of the cover. Referring initially to FIG. 6A, a first surface 106 of collector 104 is fixedly attached to surface 108 at a desired location. A second surface 110 includes a plurality of removable thin layers of polyethylene film each having an adhesive 112 thereon to collect contaminants. Once a layer becomes contaminated, it may be peeled off and discarded leaving a clean collector to attract and collect contaminants. The bond between the collectors and the cover may, as mentioned above, be any type of bond but should have a sufficient amount of strength to remain attached when one of the removable layers is pulled back and removed. A similar arrangement is utilized in manufacturing clean room entrance mats. An example of such entrance mats is STEP ONE™ adhesive mats available through Clean Room Depot. STEP ONE™ adhesive mats are made from a plurality of removable thin layers, each comprising an adhesive coated polyethylene film. The adhesive acts to remove contaminants from the bottom of shoes when an individual enters the clean room.

Referring now to FIG. 6B, another embodiment of the invention is shown. In this embodiment, the second surface 110 may include a predetermined number of thin layers that are held together by a hook and loop type fastener, such as a VELCRO® fastener. In this embodiment, an outer surface 114 of the first surface 106 comprises a plurality of loops. The second surface 110 comprises a series of thin layers each having an inner surface having hooks and an outer surface having loops, as shown in FIG. 6B. The hooks of an inner surface 116 of a first layer 118 are in contact with the loops of the outer surface 114 of the first surface 106. The hooks of the inner surface 120 of the second layer 122 are in contact with the loops of the outer surface 124 of the first layer 118. Successive layers are releasably attached exactly like the second layer 122 is attached to the first layer 118. Once a layer becomes contaminated, it may be peeled off and discarded leaving a clean collector to attract and collect contaminants. The loops and hooks are described above as being attached to a particular surface of each removable layer and it is important to note that the loops and hooks may be on either side of a removable layer. For instance, the removable layers may have loops on the inner surface and hooks on the outer surface. In such an instance, the outer surface of the first surface should have hooks.

As mentioned above, the protective covering 10, 50 may be made out of any flexible substantially air-tight material. The protective covering 10, 50 may also be reinforced with a second material to increase its overall strength and, in particular, to enhance its ability to resist tearing. For instance, for the protective coverings 10 that is to be used with a forklift, the sleeves 18, 20 may be reinforced to minimize tears in the material which can occur when picking up a pallet. For protective coverings 50 that are to be used with a pallet jack, the portion covering the forks may be reinforced, while the portion covering the handle need not be.

The thickness of the protective covering 10, 50 may vary in accordance with a specific application. For instance, the thickness of the protective covering may vary from approximately 4 mils to approximately 26 mils. Generally speaking, the portions of the protective covering 10, 50 not subjected to direct loading of pallets may be thinner than those sections that are subjected to such loading. For instance, the forks of both a forklift and a pallet jack are typically subject to the largest load forces and, therefore, are the most likely to tear or otherwise fail. Consequently, those sections of the protective covering may be thicker, in addition to or instead of being reinforced with a second material. For protective coverings 10 used with a forklift, the flexible cover 22 may be thinner than the sleeves 18, 20. For protective coverings 50 used with a pallet jack, the portion that encases the housing 56 and the handle 58 may be thinner than the portion of the covering 50 that encases the forks. While certain portions of each protective covering may be thinner or thicker than other portions, they do not have to be and in many circumstances will not be.

So far the collectors have been described as being fixedly attached to the cover. However, it is important to note that the manner in which the collectors are actually attached to the cover is a matter of design choice and may vary. For example, the collectors may be releasably attached to the cover in much the same way the removable layers of each collector are attached to one another. The collectors may also be fabricated integrally with the cover.

In another embodiment, the cover 50 may include a frame at each of the wheels, front and rear. The frame may include a means for cleaning the wheels as the wheels rotate and increase the covers ability to prevent contaminants existing on the pallet jack to escape the cover and infiltrate a controlled environment.

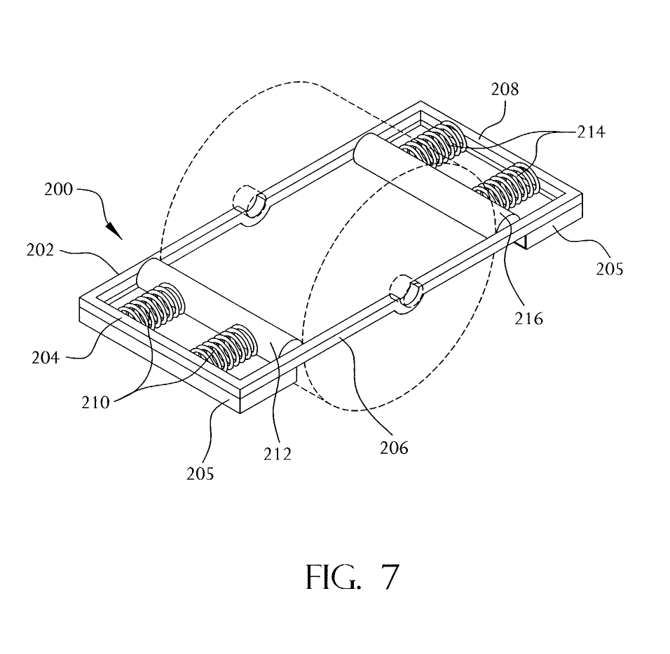

Referring initially to FIG. 7, a frame 200 adapted for use at the front wheels of a pallet jack, includes four structural members 202, 204, 206, 208 that define the frame's size and shape. It should be noted that the frame may be any size and shape and may be fabricated using any type of material. As mentioned, the frame 200 includes a means for cleaning the wheels as they rotate. In one embodiment, the means may include two spring and roller assemblies comprising springs 210, 214 and rollers 212, 216 wherein the rollers include a material for collecting contaminants. The springs may act in conjunction with the frame's structural members to bias the roller against a wheel (shown in phantom). The frame 200 may be attached to the wheel at the wheel's axle as shown in FIG. 7. To connect the frame to the wheel, the frame may be adapted to snap in place and remain attached to the wheel as desired. The means for cleaning the wheel may include other elements in lieu of springs that are capable of performing the function of biasing the roller so that the roller is in contact with the wheel. For instance, flexible bellows made of plastic, for example, may be used. Also, the frame may be adapted so that each end of the frame is contiguous up to a point where it meets the rollers, so that, for example, the space shown in FIG. 7 between the roller 212 and members 202, 204, 206 is contiguous. The rollers 212 and 216 may be made of any materials suitable for collecting contaminants from the wheel once the wheel begins to rotate. The materials identified in FIGS. 6A and 6B and described herein, for example, may be used.

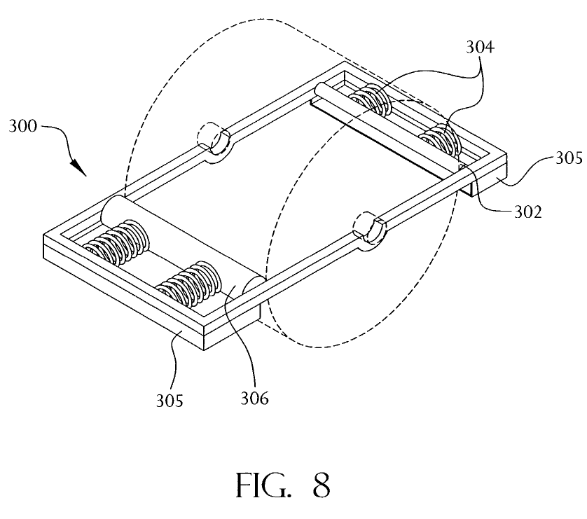

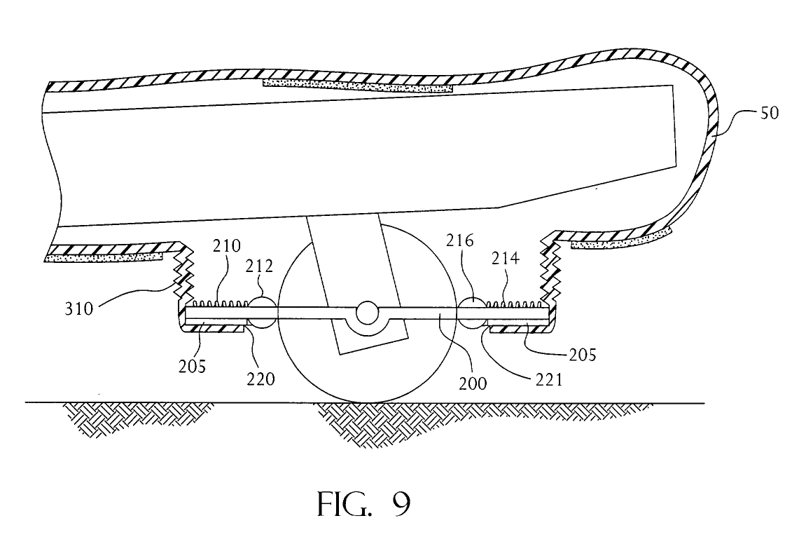

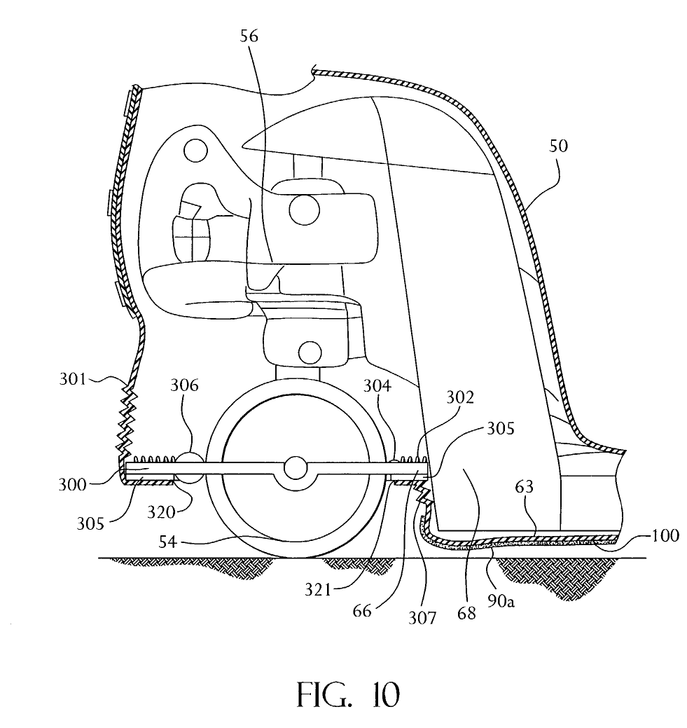

It is important to note that, where the means for cleaning the wheel is an assembly having a roller and springs, both frames 200 and 300 (see FIGS. 7 and 8) include a horizontal surface underneath the roller and springs to substantially prohibit contaminants within the cover 50, on the pallet jack or otherwise, to escape from within the cover and infiltrate a controlled environment. The horizontal surface of frame 200 is shown in FIGS. 7 and 9 and indicated with reference numeral 205. The horizontal surface of frame 300 is shown in FIGS. 8 and 10 and indicated with reference numeral 305.

Referring now to FIG. 8, a frame 300 is shown adapted for use with a rear wheel of a pallet jack. As can be seen by referring back to FIG. 5A, the space between the rear portion of the pallet jack and the inner or front portion of wheel 54 is limited. Accordingly, the frame 300 shown in FIG. 8 includes a roller 302 that is smaller in diameter than the roller 216 of frame 200 and springs 304 that are shorter in length than springs 214 of frame 200. If space is very tight or if simply more convenient, frame 300 may be adapted to not include a roller or springs on one side. In that case, the loss of cleaning capacity caused by reducing the diameter of roller 302, may be compensated for by increasing the diameter of roller 306. Other elements of the frame adapted for use with the rear wheel may be similar to that of the front wheels, as described herein.

Referring now to FIG. 9, when the frame 200 adapted for use with the front wheels of a pallet jack is used, the openings of the cover 50 that correspond to the front wheels may be configured as shown. At all four sides of an opening, the cover may extend vertically downward so as to meet the frame members 202, 204, 206, and 208. The vertical extent of the cover, indicated generally by reference numeral 310, may be configured as bellows in order to accommodate variations in the vertical distance from the frame to a supporting surface. FIG. 9 is an elevation view showing the vertical extent 310 of the cover 50 that meets members 204 and 208. The cover extends downward to meet members 202 and 206 in like fashion. The cover may extend downward and wrap underneath a portion of each end of frame 200 attaching to the frame 200 at points 220 and 221. The exact configuration in which the cover 50 extends downward, wraps underneath and attaches to frame 200 is a matter of design choice and may vary accordingly.

Where frame 300 is used with a rear wheel of a pallet jack, the cover 50 may be adapted as shown in FIG. 10. That is, referring back to FIG. 5A, the portion of the cover 50 above the rear wheel 54 may (instead of being located above the rear wheel 54) extend downward from a point behind the rear wheel as shown in FIG. 10. The vertical extent of the cover 50 is indicated generally with reference numeral 301. The cover extends downward from that point and wraps underneath the frame 300 and attaches to frame 300 at a point indicated by reference numeral 320. The portion of the cover 50 that is in front of the wheel 54 may, instead of running vertically in front of wheel 54 as shown in FIG. 5A, attach directly to frame 300. The cover 50, whose vertical extent is in front of the rear wheel 54 is indicated generally with reference numeral 307. As shown in FIG. 10, the vertical extent 307 of the cover may stop at a predetermined point and begin to extend inward toward the roller 302 and so that it may attach to frame 300 at a point indicated by reference numeral 321.

The manners of attaching the cover to the frame and the frame to the wheel (both front and back) are shown and described for illustrative purposes. The size of the pallet jack and size of the pallet jack wheels, among other factors, may require those items to be connected in a variety of ways. For example, the cover may be attached to the frame at a number of points and at different points then those shown in the figures.

FIG. 11 depicts another embodiment of the present invention. In this embodiment the invention is a protective covering 400 used to cover a hand truck 405. Hand trucks are often used in clean room settings to move heavy or awkward items from point to point. The covering 400 is a single piece with front 425 and rear 420 sections and are attached at one end. The front and rear sections 425, 420 preferably include fasteners along their respective peripheries to close them snugly around the hand truck. All or at least a portion 430 of the covering may be of a transparent material to allow the handle to be seen. Fastener 415 may be a hook and loop type fastener as shown in FIG. 11A, a sliding fastener as shown in FIG. 11B or snap fasteners as shown in FIG. 11C. The fasteners may be applied to the polymer material comprising the covering, by means of sewing, pressure sensitive adhesive or heat welding. As shown in FIGS. 11A, 11B and 11C the fasteners close around the axle 410 of the hand truck 405, leaving an opening for the axle 410 and allowing the wheels to rotate freely. The front and rear sections 425, 420 are joined at an end that has a foldable portion, at this point, the tongue or blade 435 of the hand truck 405 is inserted into the foldable portion before the covering 400 is secured around the hand truck 405. The section of the covering 400 that covers the blade 435 may be padded or reinforced to prevent tearing.

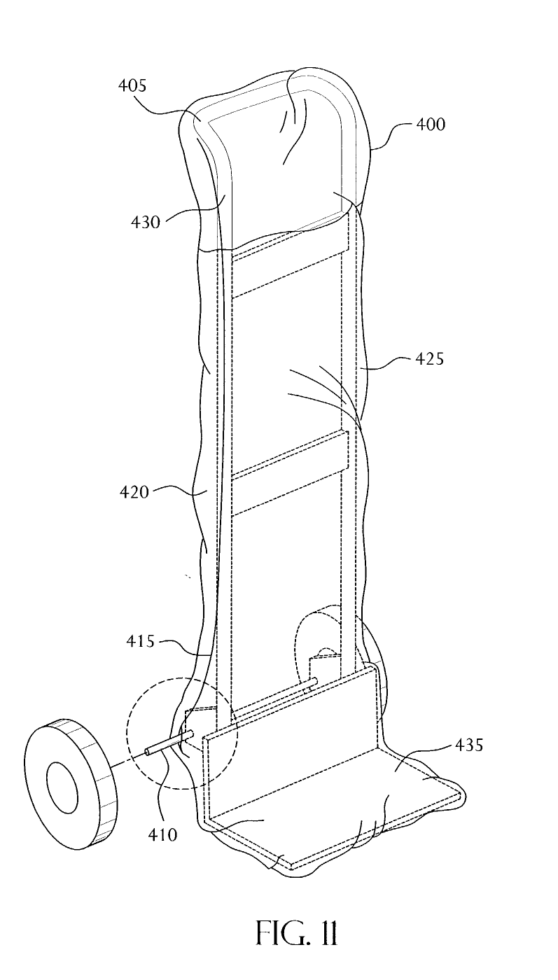

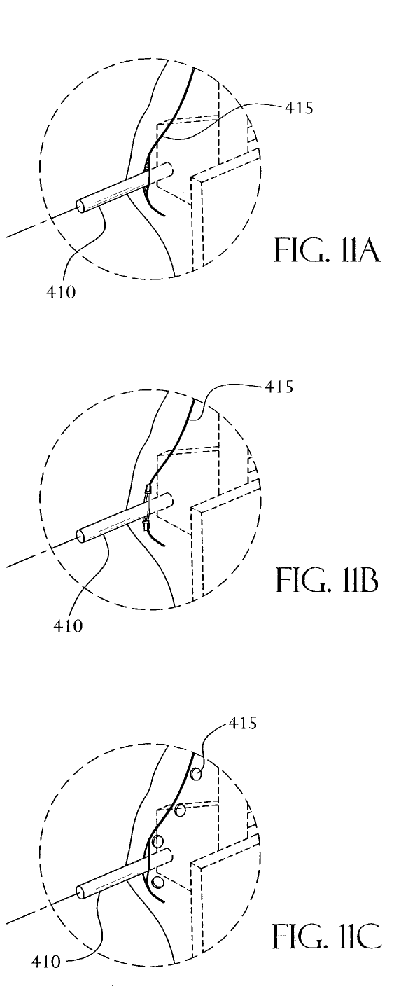

As shown in FIG. 12, another embodiment of the invention is provided. In this embodiment the invention is a protective covering 445 used with a drum 465 that is to be brought into a clean room. Drums used in clean rooms can be single use fiberboard drums or reusable plastic or metal drums. Regardless of whether a drum is single use or reusable, the drums are filled remotely and brought into a clean room setting. These drums, although clean on the inside, may carry contaminants on their outer surfaces. In this embodiment, there is provided a covering 445 having a generally cylindrical shape with a circular footprint or bottom section 450. The bottom section 450 may be lined or reinforced to prevent tearing. Extending up from the bottom section are two main sections 455, 460 that are attached to the bottom section 450. The main sections 455, 460 are configured to matingly engage each other to enclose a drum 465 once the drum 465 is in place. The main sections 455, 460 may engage each other by fasteners that are situated along their respective peripheries 470. FIG. 12 shows a sliding fastener 475. FIG. 12A shows a hook and loop type fastener 480. FIG. 12B depicts snap type fasteners 485. The protective covering may have a transparent section 490 to allow viewing of the drum 465 for contents or may be entirely transparent.

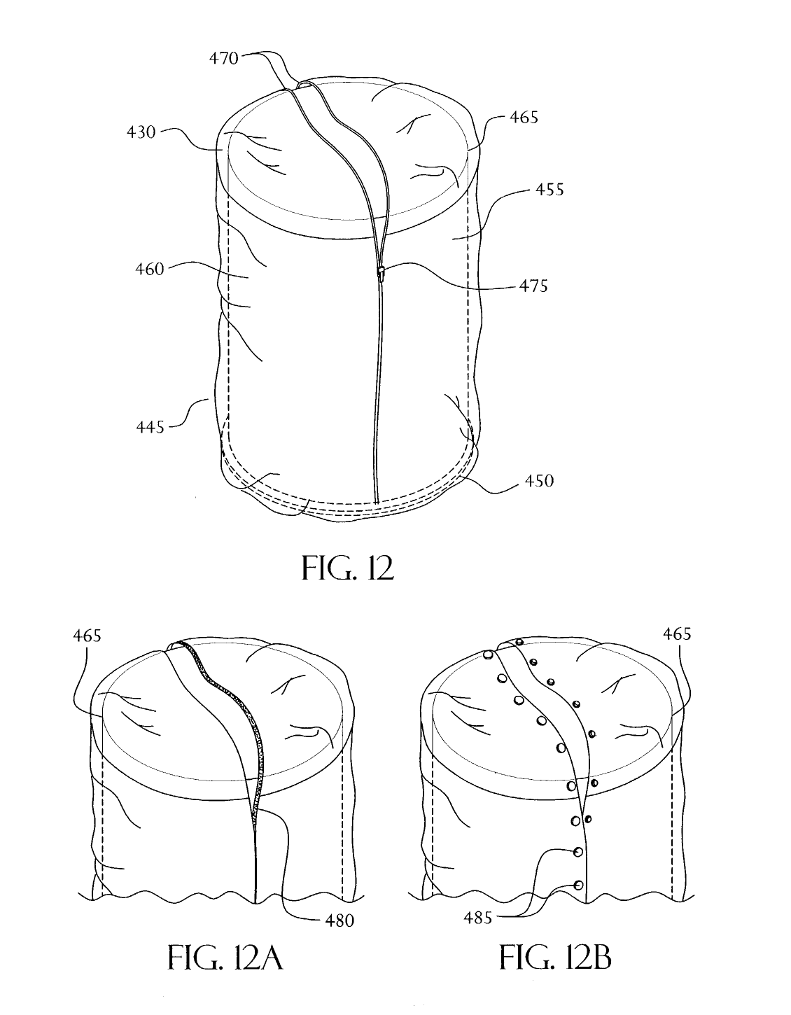

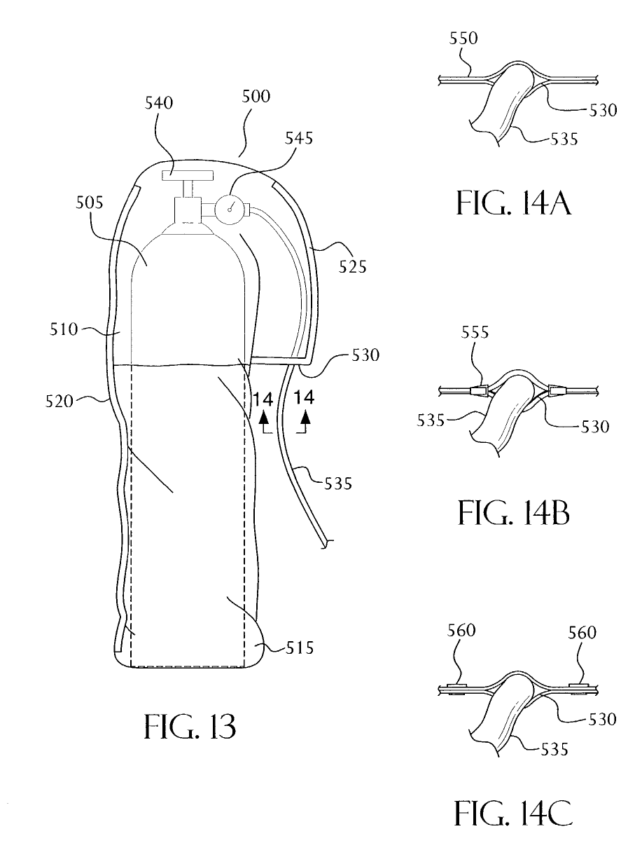

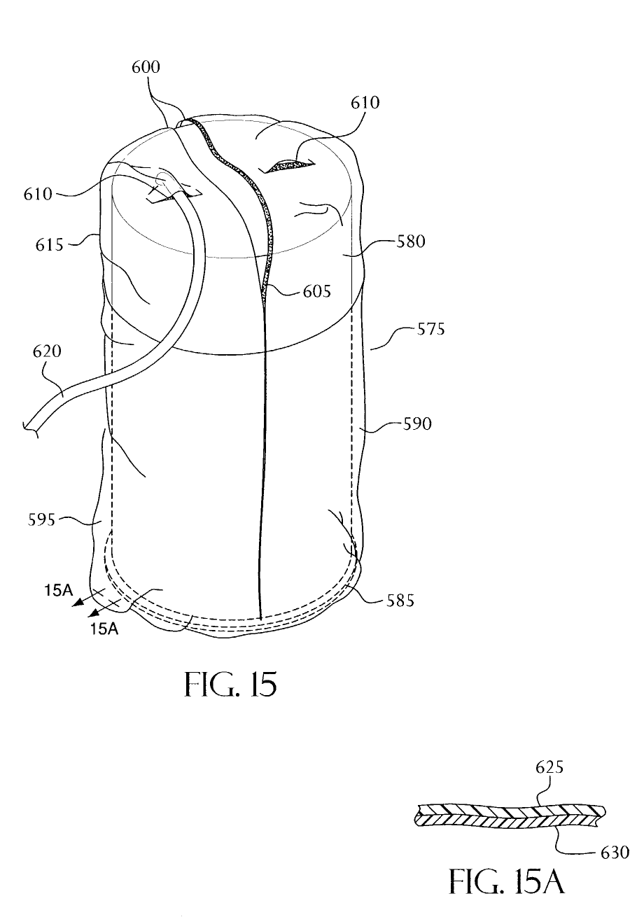

FIG. 13 depicts a still further embodiment of the present invention. In this embodiment the protective covering 500 is adapted for use with a gas tank or cylinder 505. Gas cylinders, also known as weld bottles, are often used in clean rooms as well as laboratories, hospitals, etc. to provide various gases when dedicated lines are not available. Such gas cylinders are reusable, are refilled remotely, and then brought into clean rooms, laboratories, hospitals, etc. This embodiment of the present invention provides for a protective covering 500 for such a gas cylinder 505 so that access to the controls 540 and gauges 545 is not restricted. The covering 500 is generally cylindrical in shape and has a section that is transparent 510 that allows the gauges 545 to be seen or may be entirely transparent. The covering 500 has a bottom section that is generally circular in shape and a main section 515 extending up therefrom. A closable opening 520 (shown closed) provides access inside the covering 500 where a gas cylinder 505 is placed. The peripheries of the opening are configured to matingly engage each other to close once the tank 505 is in place. The peripheries of the opening may engage each other by fasteners that are situated along their respective peripheries. The opening 520 is closable by the use of either a fastener such as hook and loop, sliding or snap fasteners. Transparent section 510 also has an opening 525 that allows a user access to the controls 540. The covering 500 also has an opening 530 to allow a hose 535 from the gas cylinder 505 out. FIG. 14A is a detail of the opening 530 that is closed around a hose 535 using hook and loop type fastener 550. FIG. 14B is a detail of the opening 530 closed around a hose 535 using a sliding fastener 555. FIG. 14C is a detail of the opening 530 closed around a hose 535 using snaps 560.

Gas cylinders under high pressure can cause frosting on their outer surfaces when they are in use. To reduce this effect, the main section 515 may have an additional inner layer or lining to act as a thermally insulating layer or to absorb moisture in the air, so that frosting does not occur.

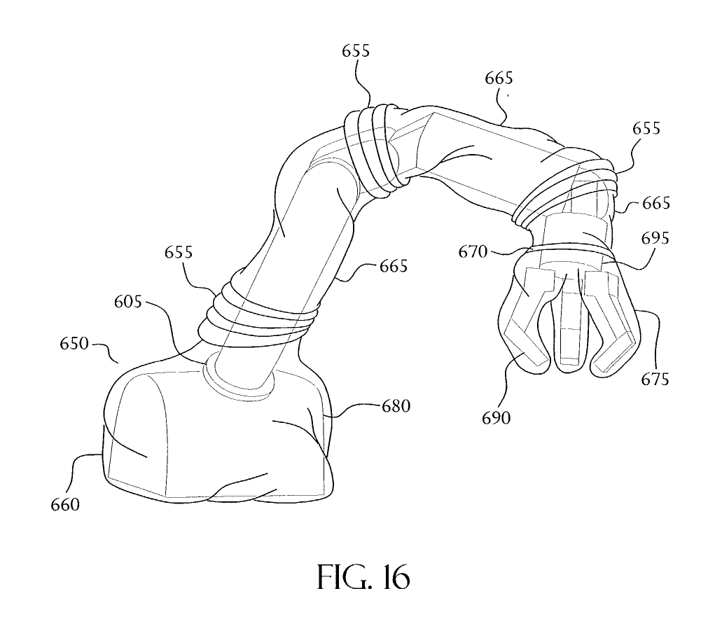

FIG. 15 is a still further embodiment of the present invention. In this embodiment the protective covering 575 is adapted for use with a Dewar flask 580. A Dewar flask is an insulated container used especially to store liquefied gases, and has a double wall with a vacuum between the walls and silvered surfaces facing the vacuum. Dewar flasks are used extensively in clean rooms but are often refilled remotely and brought into clean rooms. In this embodiment of the invention, there is provided a covering 575 having a generally cylindrical shape with a circular footprint or bottom section 585. The bottom section 585 may be lined or reinforced to prevent tearing. Extending up from the bottom section are two main sections 590, 595 attached to the bottom section 585. The main sections 590, 595 are configured to matingly engage each other to enclose a Dewar flask 580 once the Dewar flask 580 is in place. The main sections 590, 595 may engage each other by fasteners that are situated along their respective peripheries 600. FIG. 15 shows a hook and loop type fastener 605. The protective covering 575 may be closed around the Dewar flask 580 by means of a sliding fastener or snap fasteners. The protective covering 575 may have a transparent section 615 to allow viewing of gauges and connections. The protective covering 575 may also have openings 610 to allow a hose 620 to be connected to the Dewar flask 580.

Dewar flasks are used especially to store liquefied gases and may “sweat” or frost over on their outer surface. With this in mind, the main sections 590, 595 may have an additional inner layer to act as a thermally insulating layer or to absorb moisture. FIG. 15A is a sectional view of the protective covering depicts two layers, inner layer 630 and outer layer 625. Inner layer 630 may be a thermally insulating material such as Gore-Texg, neoprene, polypropylene, etc. or an absorbent material.

FIG. 16 is a still further embodiment of the present invention. In this embodiment protective covering 650 is used to enclose an articulating robotic arm 685. Articulating arms are similar to human arms and have articulating members and a joint to allow articulated motion. Such articulating arms are used extensively in pharmaceutical and semiconductor clean rooms to perform highly precise and repetitive tasks. The protective covering 650 comprises body section 660, bellows sections 655, sleeves 665, cuff 670, and glove 675. Protective covering body section 660 is shaped to conform substantially to the shape of the main base 680 of articulating arm 685. Body section 660 may be attached directly to the base 680 of articulating arm 685 by means of pressure sensitive adhesives, hook and loop type fasteners, etc. Attached to the body section are bellows 655 to allow pivoting motion of the arm 685. The bellows 655 can be attached to the body 660 by sewing, heat welding or by the use of pressure sensitive adhesives or may be integral therewith. As shown in FIG. 16, bellows 655 is attached to sleeve 665, bellows 655 can be attached to sleeve 665 by sewing, heat welding or by the use of pressure sensitive adhesives or may be integral therewith. The bellows 655 may also be releasably attached to sleeve 665 by means of hook and loop type fasteners, slidable zippers, snap type fasteners, etc. Sleeve 665 may be adapted to loosely fit around the corresponding articulating arm member so as not to restrict or confine movement of the articulating arm. The protective covering 650 of this embodiment may utilize more than one bellows 655 and sleeve 665 depending on the configuration of the articulating arm. FIG. 15 depicts a gripping device 690 which is part of the articulating arm. Such gripping devices are often capable of 3600 range of motion. To accommodate this range of motion, provided is a rigid ring-shaped cuff 670 which is attached to a sleeve 665. Also provided is a glove 675 which is adapted to fit over the gripping device 690, without restricting or confining its movement. The glove 675 has attached to its open end a rigid ring-shaped cuff that matingly engages the ring-shaped cuff 670 attached-to sleeve 665. Once attached, glove 675 is capable of 3600 range of motion. The flexible protective covering 650 may be applied to the articulating arm 685 by simply sliding it over the articulating arm 685 and attaching the body section of the covering 660 to the main body portion 680 of the articulating arm 685. The protective covering 650 may also have an opening (not shown) to allow the covering to be placed onto the articulating arm if the covering is not able to be slipped over the articulating arm. All or part of the protective covering may be made of a transparent material to allow a technician to observe the articulating arm.

While pharmaceutical clean rooms have been used to illustrate the present invention, the present invention may be used in any industry performing operations that are sensitive to contaminants. For example, the present invention may be used in conjunction with material handling equipment being used by computer chip manufacturers, hospitals, food processing plants and various scientific laboratories.

The present invention may be embodied in other specific forms without departing from the spirit or essential attributes thereof.

What is claimed is:

1. A protective covering adapted to enclose at least a portion of a material handling apparatus to contain contaminants associated with the material handling apparatus, the covering comprising:
a first and a second section adapted to allow engagement of a material handling apparatus there between; and
the first and second sections each being releasably attached to one another.

2. The protective covering of claim 1 wherein the first and second sections each comprise at least one sheet of a flexible substantially air-tight material.

3. The protective covering of claim 2 wherein the flexible substantially air-tight material is made from a polymer.

4. The protective covering of claim 3 wherein the polymer is polyethylene.

5. The protective covering of claim 2 wherein the flexible substantially air-tight material is a tear resistant material.

6. The protective covering of claim 2 wherein the flexible substantially air-tight material is at least in part transparent.

7. The protective covering of claim 2 wherein the flexible substantially air-tight material is reinforced with a second material.

8. The protective covering of claim 2 wherein the flexible substantially air-tight material is lined with a thermally insulating material.

9. The protective covering of claim 1 wherein the protective covering has a thickness of between approximately 4 mils and approximately 26 mils.

10. The protective covering of claim 1 wherein the protective covering has a thickness of between approximately 12 mils and approximately 18 mils.

11. The protective covering of claim 1 wherein the first and second sections are releasably attached to one another by means of a hook and loop type fastener.

12. The protective covering of claim 1 wherein the first and second sections are releasably attached to one another by a sliding fastener.

13. The protective covering of claim 1 wherein the first and second sections are releasably attached to one another by snap fasteners.

14. The protective covering of claim 1 wherein the material handling apparatus is a container.

15. The protective covering of claim 1 wherein the material handling apparatus is a hand truck.

16. The protective covering of claim 1 wherein the material handling apparatus is a platform truck.

17. The protective covering of claim 1 wherein the material handling apparatus is an robotic arm.

18. The protective covering of claim 14 wherein the container is a drum.

19. The protective covering of claim 14 wherein the container is a gas cylinder.

20. The protective covering of claim 14 wherein the container is a Dewar flask.

21. The protective covering of claim 14 wherein the container is a tool box.

22. A flexible protective covering adapted to enclose at least a portion of a robotic arm having an articulating member and a support assembly, said articulating member having at least one joint to allow articulated motion, the covering shaped to conform substantially to the shape of the member it encloses and comprising
a sealable opening for receiving the member to be enclosed;
at least one sleeve for substantially enclosing portions of the articulating member and
an articulated connection to connect the at least one sleeve at the joint to allow freedom of motion without binding, restricting or limiting said motion.

23. The protective covering of claim 22 wherein the at least one sleeve is joined to the support assembly by a releasable attachment.

24. The protective covering of claim 22 wherein the opening is closable with releasable fasteners.
